(19) United States
(12) Patent Application Publication
(10) Pub. No.: US 2024/0133729 A1
(43) Pub. Date: Apr. 25, 2024

(54) DETECTION DEVICE AND DETECTION METHOD

(71) Applicant: ROHM CO., LTD., Kyoto-shi (JP)

(72) Inventor: Kazuisao TSURUDA, Kyoto-shi (JP)

(21) Appl. No.: 18/403,241

(22) Filed: Jan. 3, 2024

Related U.S. Application Data
(63) Continuation of application No. PCT/JP2022/025667, filed on Jun. 28, 2022.

(30) Foreign Application Priority Data
Jul. 8, 2021 (JP) 2021-114155

(51) Int. Cl. G01F 23/292

(52) U.S. Cl. CPC G01F 23/292

(57) ABSTRACT

This detection device is provided with a transmission unit that generates electromagnetic waves, a compartment bottom portion by which electromagnetic waves are reflected, and a reception unit that receives electromagnetic waves. The transmission unit emits electromagnetic waves to a detection target region through a partition member for partitioning the detection target region from the transmission unit and the reception unit. The compartment bottom portion is provided on the optical path of the electromagnetic waves emitted from the transmission unit and reflects electromagnetic waves having passed through at least a portion of the detection target region. The reception unit receives electromagnetic waves that have been reflected by the compartment bottom portion and are inputted from the detection target region through the partition member.

### BACKGROUND

### 1. Field

The present disclosure relates to a detection device and a detection method.

### 2. Description of Related Art

Japanese Patent No. 5144175 discloses an example of a detection device that uses electromagnetic waves to detect a state of a detection subject. The detection device disclosed in Patent Literature 1 emits a terahertz electromagnetic wave to a detection subject and detects a terahertz electromagnetic wave that is reflected by the detection subject. Thus, the state of the detection subject is detected.

### BRIEF DESCRIPTION OF DRAWINGS

FIG. 1 is a schematic perspective view showing a first embodiment of a detection device.

FIG. 2 is a schematic cross-sectional view showing a detection manner of the detection device.

FIG. 3 is a schematic cross-sectional view showing a detection manner of the detection device when a detection subject is present.

FIG. 4 is a schematic cross-sectional view showing a second embodiment of a detection device.

FIG. 5 is a schematic cross-sectional view showing a third embodiment of a detection device.

FIG. 6 is a schematic cross-sectional view showing a fourth embodiment of a detection device.

FIG. 7 is a schematic cross-sectional view showing a modified example of a detection device.

FIG. 8 is a front view showing a fifth embodiment of a detection device.

FIG. 9 is a schematic end view showing the detection device of the fifth embodiment.

FIG. 10 is a schematic perspective view showing a sixth embodiment of a detection device.

FIG. 11 is a schematic cross-sectional view showing the detection device of the sixth embodiment.

FIG. 12 is a schematic cross-sectional view showing a modified example of a detection device.

FIG. 13 is a schematic cross-sectional view showing a seventh embodiment of a detection device.

FIG. 14 is a schematic cross-sectional view showing a modified example of a detection device.

FIG. 15 is a schematic cross-sectional view showing a modified example of a detection device.

### DETAILED DESCRIPTION

Embodiments of a detection device and a detection method will now be described with reference to the drawings. The embodiments described below exemplify configurations and methods for embodying a technical concept and are not intended to limit the material, shape, structure, layout, dimensions, and the like of each component to those described below. In the drawings, elements may not be drawn to scale for simplicity and clarity of illustration. In a cross-sectional view, hatching may be omitted to facilitate understanding. The accompanying drawings only illustrate embodiments of the present disclosure and are not intended to limit the present disclosure.

### First Embodiment

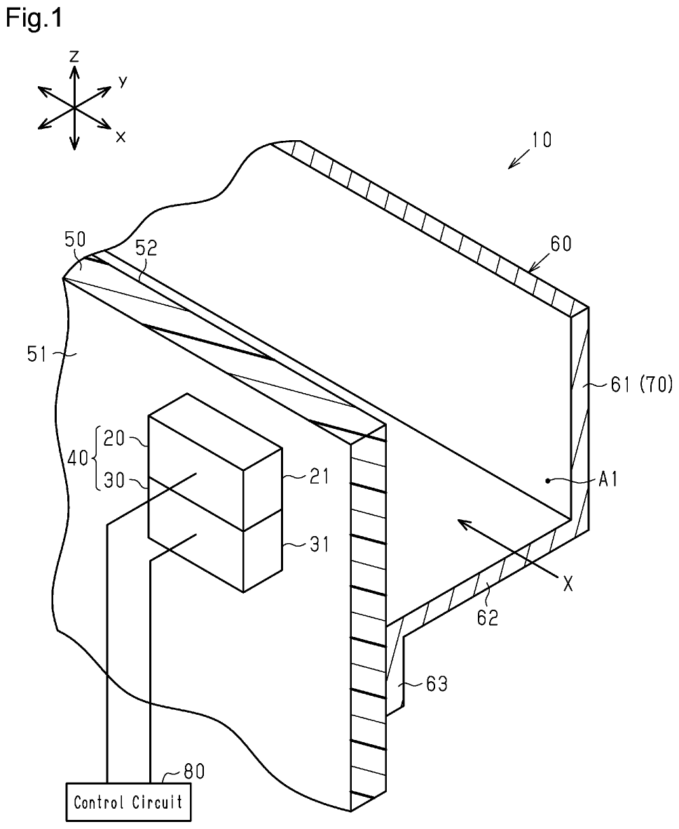

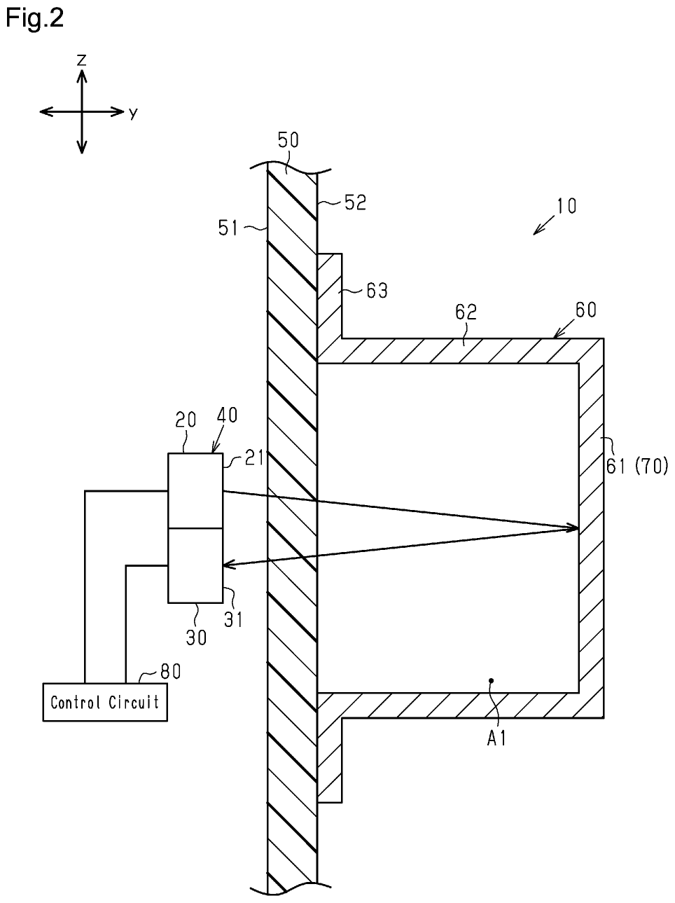

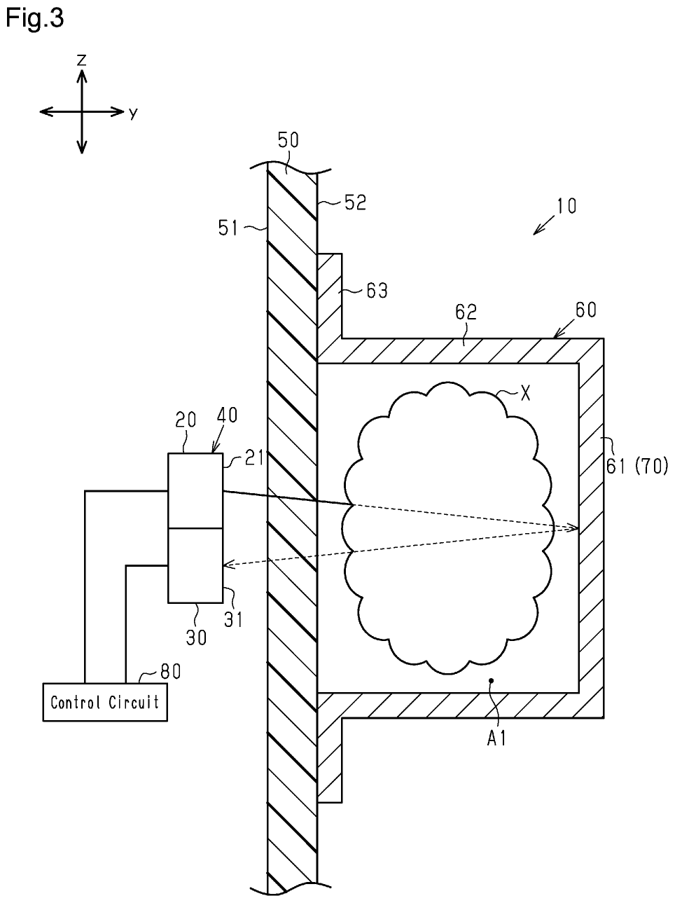

The present embodiment of a detection device 10 and a detection method will be described with reference to FIGS. 1 to 3. FIG. 1 is a schematic perspective view of the detection device 10. FIG. 1 is a partially cut-out view. FIG. 2 is a schematic cross-sectional view showing a detection manner of the detection device 10. FIG. 3 is a schematic cross-sectional view showing a detection manner of the detection device 10 when a detection subject X is present.

In the present embodiment, the detection device 10 includes a transmitter 20 configured to generate an electromagnetic wave and a receiver 30 configured to receive an electromagnetic wave.

In an example, the transmitter 20 includes an emission surface 21 that emits the electromagnetic wave and is configured to emit the electromagnetic wave from the emission surface 21. The frequency of the electromagnetic wave may be, for example, 10 GHz to 100 THz. In an example, the electromagnetic wave may include a terahertz wave of 0.1 THz to 10 THz. It is considered that the electromagnetic wave includes concepts of one or both of light and radio waves.

In an example, the transmitter 20 includes an active element and an antenna. The active element performs conversion between the electromagnetic wave (e.g., terahertz wave) and electrical energy. The antenna is formed on the emission surface 21 and emits the electromagnetic wave. The active element converts electrical energy into an electromagnetic wave, and the antenna emits the converted electromagnetic wave. Thus, the transmitter 20 emits the electromagnetic wave from the emission surface 21.

The active element is typically a resonant tunneling diode (RTD). Alternatively, the active element may be, for example, a tunnel injection transit time (TUNNETT) diode, an impact ionization avalanche transit time (IMPATT) diode, a GaAs-based field effect transistor (FET), a GaN-based FET, a high-electron-mobility transistor (HEMT), or a hetero junction bipolar transistor (HBT).

The antenna is typically a dipole antenna. However, the antenna is not limited to a dipole antenna and may be a different antenna such as a biconical antenna, a slot antenna, a patch antenna, or a loop antenna.

The electromagnetic wave is emitted in a direction away from the emission surface 21. In this case, the electromagnetic wave (e.g., terahertz wave) is emitted at a predetermined emission angle. That is, the electromagnetic wave spreads while traveling. In FIGS. 2 and 3, the electromagnetic wave is indicated by straight lines for the sake of convenience.

The receiver 30 includes a reception surface 31 configured to receive an electromagnetic wave (e.g., terahertz wave) and receives the electromagnetic wave emitted to the reception surface 31. In the same manner as the transmitter 20, in an example, the receiver 30 includes an active element performing conversion between an electromagnetic wave and electrical energy and an antenna formed on the reception surface 31. When the antenna receives an electromagnetic wave and the active element converts the electromagnetic wave into electrical energy, the receiver 30 receives (i.e., detects) the electromagnetic wave.

The transmitter 20 may have any specific configuration as long as the electromagnetic wave is generated and emitted. Also, the receiver 30 may have any specific configuration as long as the electromagnetic wave generated by the transmitter 20 is received.

In the present embodiment, the transmitter 20 and the receiver 30 are unitized. More specifically, the transmitter 20 and the receiver 30 are accommodated in a single package. The transmitter 20 and the receiver 30 are unitized so that the emission surface 21 of the transmitter 20 and the reception surface 31 of the receiver 30 face in the same direction. In the description hereafter, the unit of the transmitter 20 and the receiver 30 is referred to as a sensor unit 40 for the sake of brevity.

The detection device 10 is configured to detect the detection subject X present in a detection subject region A1 when the transmitter 20 emits an electromagnetic wave toward the detection subject region A1 through a partition member 50 and the receiver 30 receives the electromagnetic wave that is reflected. The detection of the detection subject X includes, for example, detecting whether the detection subject X is present in the detection subject region A1 or detecting a state of the detection subject X.

The detection subject X may be any subject. The detection subject X may be, for example, a liquid or a gas, that is, the detection subject X may be a fluid. In an example, the detection subject X may be a gas containing moisture.

In the present embodiment, the detection subject region A1 is defined by the partition member 50 and a compartment member 60.

In the present embodiment, the partition member 50 is arranged between the detection subject region A1 and the location of the transmitter 20 and the receiver 30 to separate the detection subject region A1 from the transmitter 20 and the receiver 30. In the present embodiment, the partition member 50 includes, for example, a wall having a predetermined thickness and including a first partition wall surface 51 and a second partition wall surface 52. The two partition wall surfaces 51 and 52 are flat and orthogonal to a thickness-wise direction of the partition member 50. The two partition wall surfaces 51 and 52 are arranged to intersect with the electromagnetic wave emitted from the transmitter 20. For the sake of convenience, in the present embodiment, the thickness-wise direction of the partition member 50 is referred to as the y-direction.

In the present embodiment, the partition member 50 is formed from a material transmissive to an electromagnetic wave. The partition member 50 may be formed from, for example, resin, glass, or wood. The partition member 50 may be formed from an opaque material. In an example, the partition member 50 is formed from an opaque resin. In this case, the partition member 50 may be referred to as a shield member that blocks visible light.

In the present embodiment, the compartment member 60 and the partition member 50 are formed separately. In the present embodiment, the compartment member 60 differs from the partition member 50 and is formed from a material that reflects an electromagnetic wave. More specifically, the compartment member 60 is formed from metal and contains, for example, Al or Cu.

In the present embodiment, the compartment member 60 is attached to the partition member 50 and defines the detection subject region A1 together with the partition member 50.

More specifically, the compartment member 60 has the form of a box having an opening toward the partition member 50 and a closed end. The compartment member 60 includes a compartment bottom 61, a compartment wall 62 extending upright from the compartment bottom 61, and a flange 63 arranged on a distal end of the compartment wall 62. When the flange 63 is fixed to the second partition wall surface 52 of the partition member 50, the compartment member 60 is attached to the partition member 50.

The opening of the compartment member 60 is closed by the partition member 50. This forms the detection subject region A1 surrounded by the compartment member 60 and the partition member 50, which are, more specifically, the inner surface of the compartment member 60 and the second partition wall surface 52. In this case, the partition member 50 and the compartment bottom 61 are opposed to each other with the detection subject region A1 disposed in between in the y-direction. The flange 63 and the partition member 50 may be fixed to each other in any manner and may be fixed by a fastening portion, for example, a screw.

As shown in FIGS. 1 and 2, in the present embodiment, the compartment member 60 is elongated in the x-direction and has a width in the z-direction, which is orthogonal to the thickness-wise direction of the partition member 50. Thus, the detection subject region A1 is elongated in the x-direction and has a width in the y-direction. In an example, the detection subject X flows in the detection subject region A1 in the x-direction. That is, in the present embodiment, the detection device 10 detects a fluid flowing in the detection subject region A1.

As shown in FIG. 2, the detection device 10 includes a reflector 70 and a control circuit 80. The reflector 70 and the control circuit 80 and the positional relationship of the sensor unit 40 will be described below.

The sensor unit 40 is arranged outside the detection subject region A1. More specifically, the sensor unit 40 is opposed to the detection subject region A1 with the partition member 50 disposed in between. In other words, the sensor unit 40 and the detection subject region A1 are located at opposite sides of the partition member 50.

In an example, the transmitter 20 is arranged so that the emission surface 21 is opposed to the first partition wall surface 51. The transmitter 20 emits the electromagnetic wave toward the first partition wall surface 51 in the y-direction. The receiver 30 is arranged so that the reception surface 31 is opposed to the first partition wall surface 51. The receiver 30 receives the electromagnetic wave transmitted from the first partition wall surface 51 in the y-direction.

In the present embodiment, the emission surface 21 is separated from the first partition wall surface 51, and the reception surface 31 is separated from the first partition wall surface 51. Alternatively, the emission surface 21 may be in contact with the first partition wall surface 51. In this case, a protection layer may be arranged on the emission surface 21 to avoid interference with the antenna of the emission surface 21. Also, the reception surface 31 may be in contact with the first partition wall surface 51. That is, the state in which one object is opposed to another object includes a state in which the two objects are in contact with each other.

The partition member 50 is located between the sensor unit 40 (namely, the transmitter 20 and the receiver 30) and the detection subject region A1 so that the transmitter 20 and the receiver 30 are partitioned from the detection subject region A1. In other words, the partition member 50 may be referred to as an intermediate member located between the sensor unit 40 and the detection subject region A1.

The sensor unit 40 may be attached to the partition member 50. In an example, a specified jig may be used to fix the sensor unit 40 to the partition member 50 so that the sensor unit 40 is opposed to the detection subject region A1 with the partition member 50 disposed in between.

The reflector 70 is arranged in an optical path of the electromagnetic wave emitted from the transmitter 20 and is configured to reflect the electromagnetic wave transmitted through at least part of the detection subject region A1. The configuration in which the electromagnetic wave transmits through at least part of the detection subject region A1 includes, for example, a configuration in which the electromagnetic wave transmits through the entirety of the detection subject region A1 in the y-direction and a configuration in which the electromagnetic wave transmits through part of the detection subject region A1 in the y-direction.

In the present embodiment, the reflector 70 is formed of the compartment member 60, more specifically, the compartment bottom 61. That is, as described above, the compartment member 60 including the compartment bottom 61 is formed from a material that reflects an electromagnetic wave. The compartment bottom 61 is arranged in the optical path of the electromagnetic wave emitted from the transmitter 20, more specifically, at a position opposed to the transmitter 20 with the partition member 50 and the detection subject region A1 disposed in between. That is, the transmitter 20, the partition member 50 and the compartment bottom 61 are arranged in the y-direction. The detection subject region A1 is located between the partition member 50 and the compartment bottom 61. When the transmitter 20 emits an electromagnetic wave, the electromagnetic wave is emitted to the compartment bottom 61 through the partition member 50 and the detection subject region A1.

The receiver 30 is configured to receive an electromagnetic wave that is reflected by the reflector 70 and transmitted from the detection subject region A1 through the partition member 50. More specifically, the receiver 30 is opposed to the reflector 70 (in the present embodiment, the compartment bottom 61) with the partition member 50 and the detection subject region A1 disposed in between. Part or the entirety of the electromagnetic wave reflected by the compartment bottom 61 transmits through the detection subject region A1 and the partition member 50 and reaches the receiver 30. Thus, the receiver 30 receives the electromagnetic wave. The receiver 30 is configured to receive an electromagnetic wave that is reflected by the compartment member 60 (i.e., the compartment bottom 61) as the reflector 70 and transmitted through the detection subject region A1 and the partition member 50.

The control circuit 80 is electrically connected to the transmitter 20 and the receiver 30. In an example, the control circuit 80 controls the transmitter 20 so that the transmitter 20 emits an electromagnetic wave. In addition, the control circuit 80 determines whether the detection subject X is present in the detection subject region A1 or determines the state of the detection subject X based on the electromagnetic wave received by the receiver 30.

The control circuit 80 may make the determination in any specific manner. In an example, when the detection subject X has characteristics that absorb or disperse an electromagnetic wave, the control circuit 80 may determine whether the detection subject X is present based on the strength of the electromagnetic wave emitted from the transmitter 20 and the strength of the electromagnetic wave received by the receiver 30. In the description hereafter, the strength of the electromagnetic wave emitted from the transmitter 20 is referred to as “transmission strength.” The strength of the electromagnetic wave received by the receiver 30 is referred to as “reception strength.”

In an example, when the ratio of the reception strength to the transmission strength is greater than or equal to a predetermined threshold ratio, the control circuit 80 may determine that the detection subject X is not present in the detection subject region A1. When the ratio is less than the threshold ratio, the control circuit 80 may determine that the detection subject X is present in the detection subject region A1. Alternatively, the control circuit 80 may determine whether the detection subject X is present based on the difference between the transmission strength and the reception strength.

When the detection subject X contains moisture, the control circuit 80 may determine the amount of moisture in the detection subject X from the reception strength. More specifically, the electromagnetic wave attenuates due to moisture. As the amount of moisture in the detection subject X increases, the reception strength is more likely to decrease. Thus, the control circuit 80 may determine that the detection subject X contains a large amount of moisture as the reception strength decreases.

A detection method using the detection device 10 will now be described with reference to FIGS. 2 and 3.

The detection method includes a step of emitting an electromagnetic wave from the transmitter 20 toward the detection subject region A1 through the partition member 50. More specifically, the control circuit 80 controls the transmitter 20 so that the transmitter 20 emits an electromagnetic wave. The electromagnetic wave emitted from the transmitter 20 enters the detection subject region A1 through the partition member 50.

As shown in FIG. 3, if the detection subject X is present in the detection subject region A1, the electromagnetic wave interacts with the detection subject X. Thus, the electromagnetic wave is absorbed or dispersed by the detection subject X. As a result, the electromagnetic wave attenuates while transmitting.

If the detection subject X is not present in the detection subject region A1, the interaction of the electromagnetic wave with the detection subject X will not occur. The electromagnetic wave transmits without being absorbed or dispersed by the detection subject X. Therefore, the electromagnetic wave is less likely to attenuate.

The detection method includes a step of reflecting, with the reflector 70, the electromagnetic wave that is transmitted through the partition member 50 and at least part of the detection subject region A1. The electromagnetic wave reflected by the reflector 70 transmits toward the receiver 30 again through the detection subject region A1 and the partition member 50.

The detection method includes a step of receiving, with the receiver 30, the electromagnetic wave that is reflected by the reflector 70 and transmitted from the detection subject region A1 through the partition member 50. With this structure, the strength of the received electromagnetic wave varies in accordance with whether the detection subject X is present in the detection subject region A1 or the state of the detection subject X. This allows for detection of whether the detection subject X is present or the state of the detection subject X.

Advantages

The present embodiment, which has been described above, has the following advantages.

(1-1) The detection device 10 includes the transmitter 20 configured to generate an electromagnetic wave, the reflector 70 configured to reflect an electromagnetic wave, and the receiver 30 configured to receive an electromagnetic wave. The transmitter 20 emits the electromagnetic wave toward the detection subject region A1 through the partition member 50, which partitions the transmitter 20 and the receiver 30 from the detection subject region A1. The reflector 70 is arranged in the optical path of the electromagnetic wave emitted from the transmitter 20 and is configured to reflect the electromagnetic wave transmitted through at least part of the detection subject region A1. The receiver 30 is configured to receive an electromagnetic wave that is reflected by the reflector 70 and transmitted from the detection subject region A1 through the partition member 50.

With this structure, the strength of the electromagnetic wave received by the receiver 30 changes in accordance with whether the detection subject X is present in the detection subject region A1 or the state of the detection subject X. Thus, whether the detection subject X is present in the detection subject region A1 or the state of the detection subject X is detected.

The transmitter 20 is configured to emit the electromagnetic wave to the detection subject region A1 through the partition member 50. The receiver 30 receives the electromagnetic wave transmitted from the detection subject region A1 through the partition member 50. Thus, the detection subject X is detected through the partition member 50 from the outside of the detection subject region A1 in a nondestructive manner. With this structure, the detection subject X is readily detected as compared to a structure in which the transmitter 20 and the receiver 30 are arranged in the detection subject region A1.

In addition, the present embodiment, in which the reflector 70 is arranged, has a configuration that receives (i.e., detects) an electromagnetic wave reflected by the reflector 70. This improves the detection accuracy.

In a configuration that receives an electromagnetic wave reflected by the detection subject X, the strength of the received electromagnetic wave is likely to be decreased. Such a configuration is susceptible to noise. In particular, when the detection subject X is not present, the strength of the received electromagnetic wave will be zero. In this configuration, changes in the strength due to whether the detection subject X is present are slight, so that the detection accuracy is likely to be decreased. In addition, in the configuration that receives an electromagnetic wave reflected by the detection subject X, the strength of the electromagnetic wave may be decreased depending on the refractive index of the partition member 50 and the refractive index of the detection subject X. This may decrease the detection accuracy.

In this regard, in the present embodiment, the receiver 30 is configured to receive the electromagnetic wave reflected by the reflector 70. When the detection subject X is not present, the reception strength is likely to be increased. This tends to increase the difference in the reception strength between when the electromagnetic wave attenuates as a result of an interaction with the detection subject X and when such an interaction does not occur. Thus, the present embodiment is less affected by noise and improves the detection accuracy.

(1-2) The reflector 70 extends the optical path from the transmitter 20 to the receiver 30. This facilitates the interaction between the detection subject X and the electromagnetic wave, thereby improving the detection accuracy.

In an example, if the reflector 70 is omitted from the present embodiment, the receiver 30 may be arranged to be opposed to the transmitter 20. In this case, the receiver 30 needs to be separated from the partition member 50 to obtain an optical path having an equivalent length to when the reflector 70 is provided. In this regard, in the present embodiment, the reflector 70 causes the electromagnetic wave to transmit through the detection subject region A1 twice before the electromagnetic wave transmits from the transmitter 20 to the receiver 30. This ensures the length of the optical path while limiting enlargement in the y-direction.

(1-3) The partition member 50 is formed from a material transmissive to an electromagnetic wave. This allows the electromagnetic wave to transmit through the partition member 50 and enter the detection subject region A1 without the need for special processing on the partition member 50.

(1-4) The detection device 10 includes the compartment member 60 attached to the partition member 50 and defining the detection subject region A1 together with the partition member 50. The compartment member 60, which forms the reflector 70, is formed from a material that reflects the electromagnetic wave. The receiver 30 is configured to receive the electromagnetic wave that is reflected by the compartment member 60 and transmitted from the detection subject region A1 through the partition member 50.

In this structure, the compartment member 60, which defines the detection subject region A1, is used as the reflector 70. Thus, there is no need to separately arrange the reflector 70. This allows the advantage (1-1) to be relatively easily obtained.

(1-5) The compartment member 60 includes the compartment bottom 61 opposed to the transmitter 20 with the partition member 50 and the detection subject region A1 disposed in between. The receiver 30 is opposed to the reflector 70 with the partition member 50 and the detection subject region A1 disposed in between. The receiver 30 receives the electromagnetic wave that is reflected by the reflector 70 and transmitted through the detection subject region A1 and the partition member 50.

In this structure, the compartment bottom 61 is used as the reflector 70. In this case, the electromagnetic wave transmits through the detection subject region A1 and is reflected by the reflector 70, and then the electromagnetic wave again transmits through the detection subject region A1 and is received by the receiver 30. This extends the path in which the electromagnetic wave transmits in the detection subject region A1, thereby increasing the effect of the interaction between the electromagnetic wave and the detection subject X. Thus, the detection accuracy is improved.

(1-6) The electromagnetic wave includes a terahertz wave. The terahertz wave is transmissive to paper, wood, resin, and glass. This increases the degree of freedom for selecting the partition member 50 and thus improves the versatility of the detection device 10.

(1-7) The detection subject X includes a gas or a liquid. When the detection subject X includes a gas or a liquid, diffusion and leakage of the detection subject X are concerns. In this regard, in the present embodiment, the partition member 50 partitions the transmitter 20 and the receiver 30 from the detection subject region A1. This avoids, for example, exposure of the transmitter 20 and the receiver 30 to the detection subject X. The gas or liquid flowing in the detection subject region A1 is detected from the outside of the detection subject region A1. Thus, the gas or liquid is detected in a preferred manner.

(1-8) The detection method is for detecting the detection subject X present in the detection subject region A1 using the detection device 10 including the transmitter 20 and the receiver 30. The detection method includes a step of emitting an electromagnetic wave from the transmitter 20 toward the detection subject region A1 through the partition member 50 and a step of reflecting, with the reflector 70, the electromagnetic wave that is transmitted through at least part of the detection subject region A1. The reflector 70 is arranged in the optical path of the electromagnetic wave emitted from the transmitter 20. The detection method further includes a step of receiving, with the receiver 30, the electromagnetic wave that is reflected by the reflector 70 and transmitted from the detection subject region A1 through the partition member 50. Thus, the advantage (1-1) is obtained.

### Second Embodiment

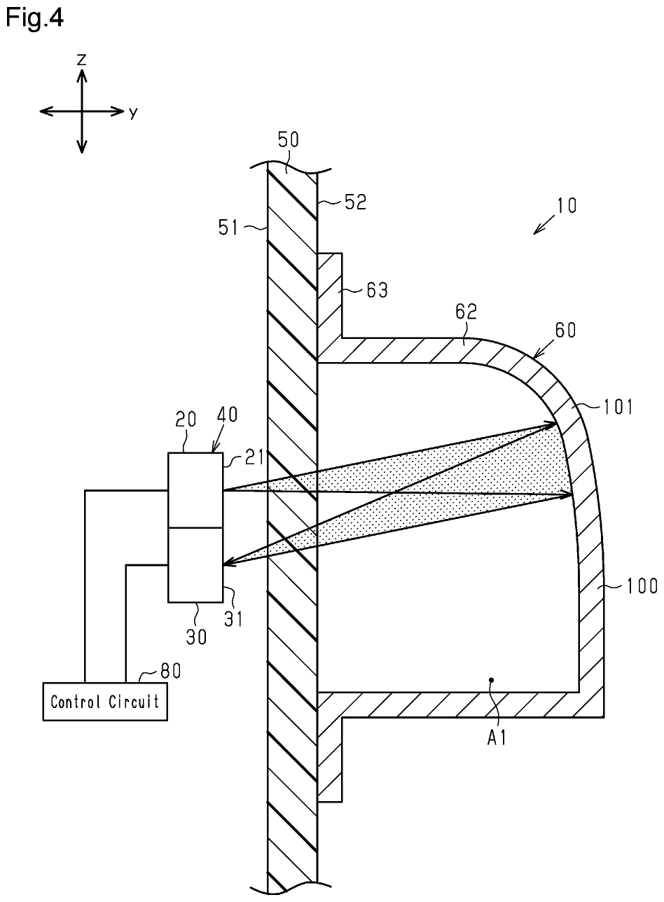

A second embodiment of the detection device 10 will now be described with reference to FIG. 4. The detection device 10 of the present embodiment differs from the detection device 10 of the first embodiment in the structure of a portion of the compartment member 60. In the description below, the same reference characters are given to those components that are the same as the corresponding components of the first embodiment. Such components will not be described in detail.

As shown in FIG. 4, when emitted, the electromagnetic wave is spread at a predetermined emission angle. Accordingly, in the present embodiment, a compartment bottom 100 includes a curved portion 101 that is curved so as to collect the electromagnetic wave toward the receiver 30. The curved portion 101 is arranged separately from the transmitter 20 in a direction in which the electromagnetic wave is emitted from the transmitter 20. The curved portion 101 is concaved in the emission direction of the electromagnetic wave from the transmitter 20.

In an example, the curved portion 101 may be curved so that the focal point is oriented toward the receiver 30, and more preferably, so that the focal point coincides with the oscillation point of the receiver 30. In the present embodiment, the compartment bottom 100, more specifically, the curved portion 101, corresponds to the “reflector.”

In the present embodiment, the curved portion 101 is defined by a portion of the compartment bottom 100, more specifically, a portion of the compartment bottom 100 opposed to the transmitter 20 in the y-direction. Alternatively, the curved portion 101 may be defined by the entirety of the compartment bottom 100.

Operation and Advantages

The present embodiment, which has been described above, has the following operational advantages.

(2-1) The compartment bottom 100, as the reflector, includes the curved portion 101 arranged separately from the transmitter 20 in a direction in which the electromagnetic wave is emitted from the transmitter 20. The curved portion 101 is concaved in the emission direction of the electromagnetic wave from the transmitter 20. Thus, the electromagnetic wave emitted from the transmitter 20 is reflected and collected toward the receiver 30. This increases the reception strength, thereby further improving the detection accuracy.

### Third Embodiment

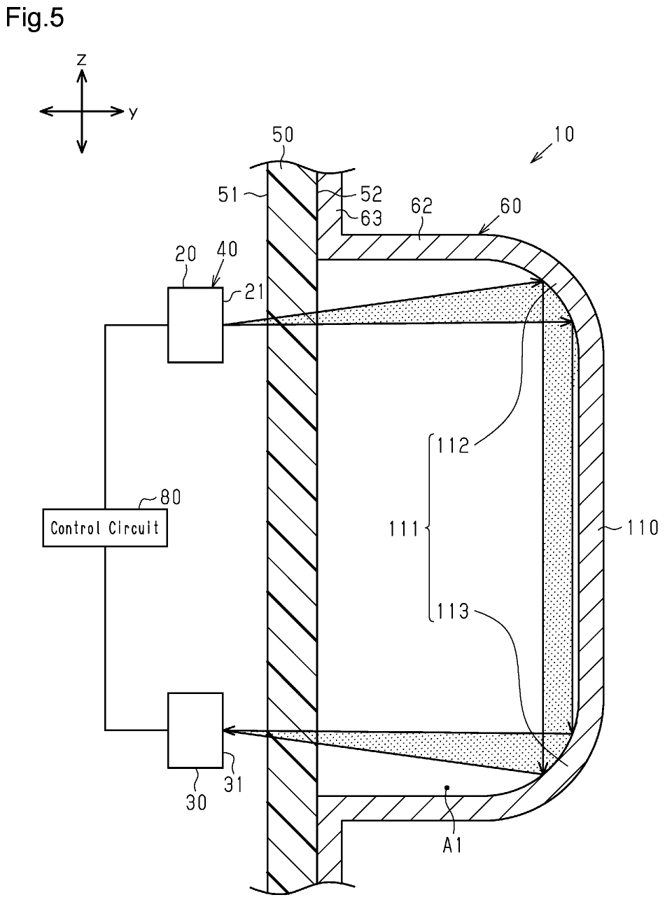

A third embodiment of the detection device 10 will now be described with reference to FIG. 5. The detection device 10 of the present embodiment differs from the detection device 10 of the first embodiment in the structure of a portion of the compartment member 60 and the layout of the sensor unit 40. In the description below, the same reference characters are given to those components that are the same as the corresponding components of the first embodiment. Such components will not be described in detail.

As shown in FIG. 5, the transmitter 20 may be arranged separately from the receiver 30. In an example, the transmitter 20 is separated from the receiver 30 in the z-direction. In the present embodiment, a compartment bottom 110 extends in the z-direction corresponding to the positions of the transmitter 20 and the receiver 30. The transmitter 20 and the receiver 30 are arranged to be opposed in the y-direction to opposite ends of the compartment bottom 110 in the z-direction.

The transmitter 20 and the receiver 30 may be separated from each other and unitized so that the relative position remains the same. However, the transmitter 20 and the receiver 30 do not necessarily have to be unitized. In this case, the transmitter 20 and the receiver 30 may be separately attached to the partition member 50.

In the present embodiment, a reflector 111 includes multiple mirror portions 112 and 113. In the present embodiment, the multiple mirror portions 112 and 113 are arranged on the compartment bottom 110. In an example, the two mirror portions 112 and 113 are arranged on the opposite ends of the compartment bottom 110 in the z-direction.

An electromagnetic wave emitted from the transmitter 20 is configured to transmit via the multiple mirror portions 112 and 113 and reach the receiver 30. More specifically, the first mirror portion 112 is arranged separately from the transmitter 20 in a direction in which the electromagnetic wave is emitted from the transmitter 20. The electromagnetic wave emitted from the transmitter 20 is reflected by the first mirror portion 112 toward the second mirror portion 113.

In the present embodiment, the first mirror portion 112 is concaved in the emission direction of the electromagnetic wave emitted from the transmitter 20. More specifically, the first mirror portion 112 is curved so that the reflected wave is in a collected state and is transmitted toward the second mirror portion 113. The collected state may be a state in which the electromagnetic wave is not spread and includes a state in which the electromagnetic wave has a constant width.

The second mirror portion 113 is arranged in an emission direction of the reflected wave, which is reflected by the first mirror portion 112, from the first mirror portion 112. More specifically, the second mirror portion 113 is separated from the first mirror portion 112 in the z-direction. The detection subject region A1 is located between the first mirror portion 112 and the second mirror portion 113.

The second mirror portion 113 and the receiver 30 are opposed to each other in the y-direction. The electromagnetic wave reflected by the first mirror portion 112 is further reflected by the second mirror portion 113 toward the receiver 30. The receiver 30 receives the electromagnetic wave reflected by the second mirror portion 113.

In the present embodiment, the second mirror portion 113 is concaved in a direction away from the receiver 30. In an example, the second mirror portion 113 may be curved so that the focal point is oriented toward the receiver 30, and more preferably, so that the focal point coincides with the oscillation point of the receiver 30. The electromagnetic wave reflected by the second mirror portion 113 is collected and transmitted toward the receiver 30.

More specifically, the detection method of the present embodiment includes a step of emitting an electromagnetic wave from the transmitter 20 toward the detection subject region A1 through the partition member 50, and a step of reflecting the electromagnetic wave emitted from the transmitter 20 toward the second mirror portion 113 using the first mirror portion 112. The detection subject region A1 is located between the first mirror portion 112 and the second mirror portion 113. The detection method further includes a step of receiving, with the receiver 30, the electromagnetic wave that is reflected by the second mirror portion 113 and transmitted from the detection subject region A1 through the partition member 50.

Operation

The operation of the present embodiment will now be described.

As shown in FIG. 5, an electromagnetic wave emitted from the transmitter 20 transmits via the first mirror portion 112 and the second mirror portion 113 and reaches the receiver 30. Thus, the optical path in which the electromagnetic wave transmits through the detection subject region A1 is extended by the length corresponding to at least the distance between the two mirror portions 112 and 113. This facilitates the interaction between the electromagnetic wave and the detection subject X.

Advantages

The present embodiment, which has been described above, has the following advantages.

(3-1) The reflector 111 includes the first mirror portion 112 and the second mirror portion 113 as the multiple mirror portions. The first mirror portion 112 is arranged separately from the transmitter 20 in the emission direction of the electromagnetic wave emitted from the transmitter 20 and reflects the electromagnetic wave emitted from the transmitter 20. The electromagnetic wave reflected by the first mirror portion 112 is further reflected by the second mirror portion 113. The detection subject region A1 is located between the two mirror portions 112 and 113. The electromagnetic wave emitted from the transmitter 20 is configured to transmit via the multiple mirror portions 112 and 113 and reach the receiver 30.

In this structure, the electromagnetic wave emitted from the transmitter 20 is reflected by the multiple mirror portions 112 and 113 and reaches the receiver 30. This extends the optical path in which the electromagnetic wave transmits from the transmitter 20 to the receiver 30. This facilitates the interaction between the electromagnetic wave and the detection subject X, thereby increasing the detection accuracy.

(3-2) The first mirror portion 112 is concaved in the emission direction of the electromagnetic wave transmitting toward the first mirror portion 112, that is, the electromagnetic wave emitted from the transmitter 20. The second mirror portion 113 is concaved in a direction away from the receiver 30.

In this structure, the electromagnetic wave emitted from the transmitter 20 is collected and reflected toward the second mirror portion 113. The collected electromagnetic wave is emitted from the second mirror portion 113 toward the receiver 30. This improves the reception strength.

In the present embodiment, the transmitter 20 is separated from the receiver 30 in the z-direction. However, there is no limit to this structure. In an example, the transmitter 20 and the receiver 30 may be separated from each other in the x-direction or in both the x-direction and the z-direction.

More specifically, when the detection subject X is a fluid flowing in the x-direction, the transmitter 20 and the receiver 30 may be separated from each other in a downstream direction of the detection subject X or may be arranged in a direction (z-direction) orthogonal to the downstream direction.

The two mirror portions 112 and 113 may be joined with each other. In an example, the detection device 10 may include the two mirror portions 112 and 113 and a single mirror member that joints the two mirror portions 112 and 113.

### Fourth Embodiment

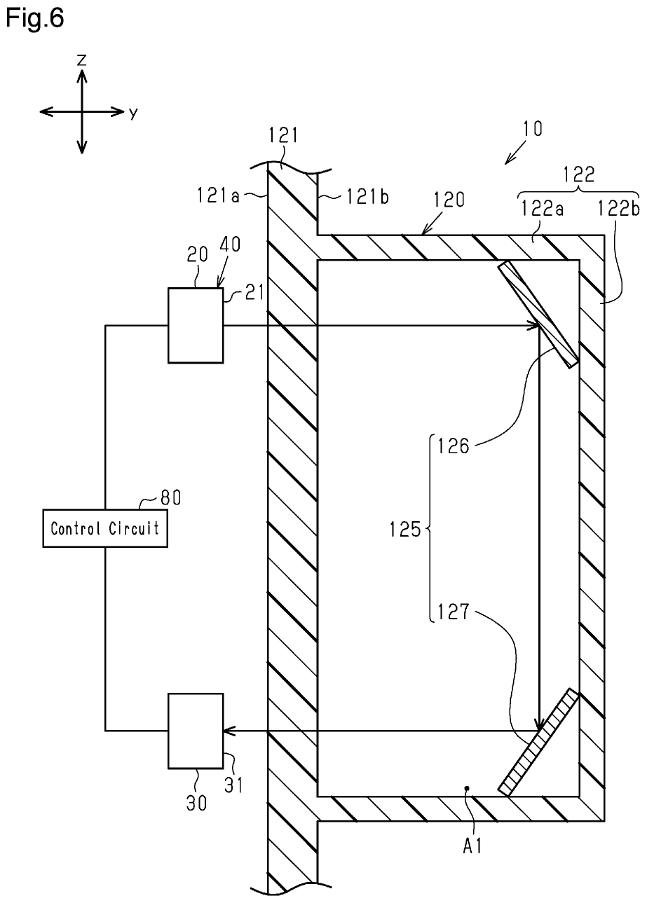

A fourth embodiment of the detection device 10 will now be described with reference to FIG. 6. The detection device 10 of the present embodiment differs from the detection device 10 of the third embodiment in the structure reflecting the electromagnetic wave. In the description below, the same reference characters are given to those components that are the same as the corresponding components of the third embodiment. Such components will not be described in detail.

As shown in FIG. 6, a reflector 125 may be arranged separately from a compartment bottom 122b.

In an example, in the present embodiment, a partition member 120 is formed from a material transmissive to an electromagnetic wave. In the present embodiment, the partition member 120 includes a body 121 and a compartment portion 122 formed integrally with the body 121.

In an example, the body 121 is a wall having a thickness in the y-direction. The body 121 includes a first partition wall surface 121a and a second partition wall surface 121b that intersect with (extend orthogonal to) the y-direction.

The compartment portion 122 defines the detection subject region A1 together with the body 121. The compartment portion 122 includes a compartment wall 122a extending upright from the second partition wall surface 121b in the y-direction and a compartment bottom 122b arranged separately from the body 121 in the y-direction and joined to the compartment wall 122a. Thus, the second partition wall surface 121b and the inner surface of the compartment portion 122 form the detection subject region A1.

In the present embodiment, the body 121 and the compartment portion 122 are formed integrally. Thus, there is no gap between the compartment portion 122 and the body 121. This limits leakage of the detection subject X from the gap. The compartment portion 122 may have any specific shape.

In this structure, the reflector 125 of the present embodiment is arranged in the detection subject region A1. In an example, the reflector 125 includes a first mirror portion 126 and a second mirror portion 127 that are arranged in the detection subject region A1 separately from the compartment bottom 122b.

In an example, the first mirror portion 126 and the second mirror portion 127 are formed from a material that reflects an electromagnetic wave. In the present embodiment, the two mirror portions 126 and 127 are formed of a metal plate.

In the present embodiment, the two mirror portions 126 and 127 are flat. Alternatively, the two mirror portions 126 and 127 may be, for example, curved in the same manner as the two mirror portions 112 and 113 of the third embodiment.

In the present embodiment, the transmitter 20 and the receiver 30 are separated in the z-direction in the same manner as the third embodiment. In this structure, the first mirror portion 126 is opposed to the transmitter 20 with the body 121 of the partition member 120 disposed in between in the y-direction. The second mirror portion 127 is opposed to the receiver 30 with the body 121 of the partition member 120 disposed in between in the y-direction. The two mirror portions 126 and 127 are separated and opposed to each other in the z-direction. The detection subject region A1 is located between the two mirror portions 126 and 127.

The electromagnetic wave emitted from the transmitter 20 is reflected by the first mirror portion 126 toward the second mirror portion 127. More specifically, the first mirror portion 126 is inclined from the emission direction (specifically, the y-direction) of the electromagnetic wave emitted from the transmitter 20 and an opposing direction (specifically, the z-direction) of the two mirror portions 126 and 127.

The electromagnetic wave reflected by the first mirror portion 126 is reflected by the second mirror portion 127 toward the receiver 30. More specifically, the second mirror portion 127 is inclined from the opposing direction (specifically, the z-direction) of the two mirror portions 126 and 127 and an opposing direction (specifically, the y-direction) of the receiver 30 and the second mirror portion 127.

Operation and Advantages

The present embodiment, which has been described above, has the following operational advantages.

(4-1) The reflector 125 is arranged separately from the compartment bottom 122b. This eliminates the need to change the shape of the compartment bottom 122b so that the electromagnetic wave is reflected in a desirable direction. This avoids disadvantages resulting from a change in the shape of the compartment bottom 122b, which are, for example, a decrease in the cross-sectional area of the detection subject region A1 and interference with the flow of the detection subject X in the detection subject region A1.

(4-2) In the present embodiment, the partition member 120 is formed from a material transmissive to an electromagnetic wave. Thus, the electromagnetic wave transmits through the partition member 120. The partition member 120 includes the body 121 and the compartment portion 122 formed integrally with each other. This limits leakage of the detection subject X from the gap between the body 121 and the compartment portion 122.

Since the body 121 and the compartment portion 122 are formed integrally with each other, it is difficult to form the body 121 and the compartment portion 122 from different materials. In this regard, in the present embodiment, the reflector 125 is arranged separately from the partition member 120. Thus, even when the compartment portion 122 is formed from a material that is transmissive to the electromagnetic wave, the reflector 125 reflects the electromagnetic wave, thereby extending the optical path.

The body 121 and the compartment portion 122 may be formed separately. In this case, the compartment portion 122 may be attached to the body 121.

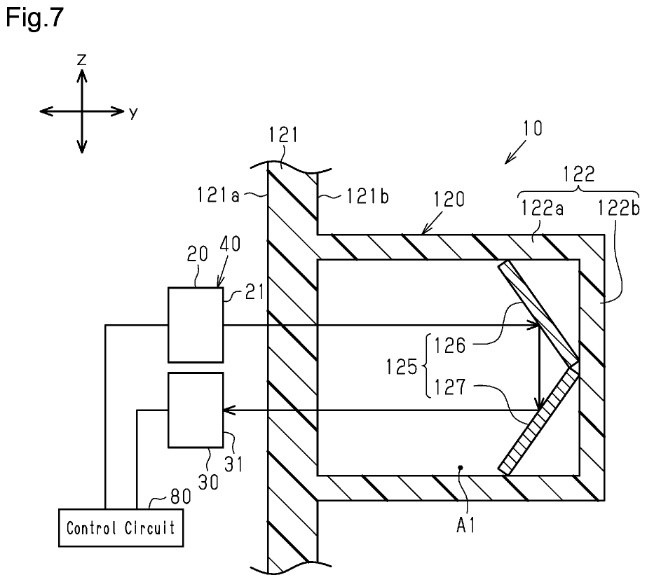

As shown in FIG. 7, the two mirror portions 126 and 127 may be located close to each other. In an example, the two mirror portions 126 and 127 may be arranged so that ends of the two mirror portions 126 and 127 are in contact with each other.

The transmitter 20 may be separated from the receiver 30 in the x-direction. In this case, accordingly, the two mirror portions 126 and 127 may be separated from each other in the x-direction.

The two mirror portions 126 and 127 may be arranged near a center of the detection subject region A1 in the y-direction, between the center and the compartment bottom 122b, or between the center and the body 121. In this case, the electromagnetic wave transmits through part of the detection subject region A1 in the y-direction and is reflected.

### Fifth Embodiment

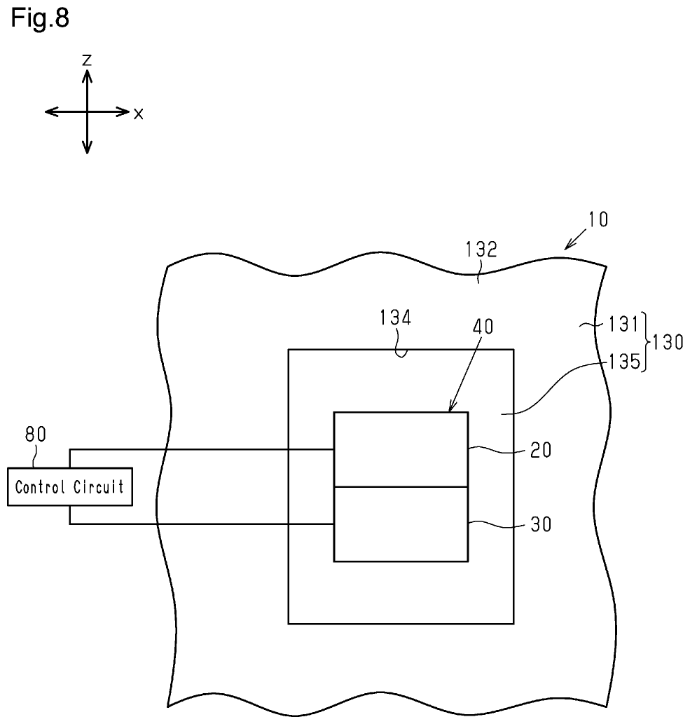

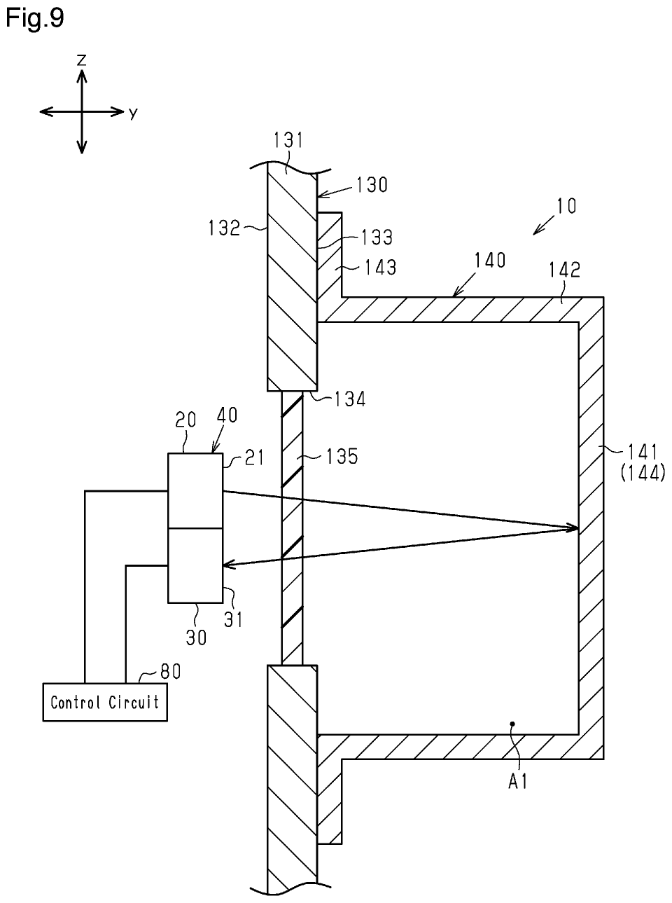

A fifth embodiment of the detection device 10 will now be described with reference to FIGS. 8 and 9. The detection device 10 of the present embodiment differs from the detection device 10 of the first embodiment in the structure of a compartment member 130. In the description below, the same reference characters are given to those components that are the same as the corresponding components of the first embodiment. Such components will not be described in detail.

As shown in FIGS. 8 and 9, the compartment member 130 of the present embodiment includes a body 131 formed from a material that reflects an electromagnetic wave and a window 135 formed from a material that is transmissive to an electromagnetic wave.

In an example, the body 131 is a wall having a thickness in the emission direction (specifically, the y-direction) of the electromagnetic wave emitted from the transmitter 20. The body 131 includes a first partition wall surface 132 and a second partition wall surface 133 that intersect with the y-direction. The body 131 is formed from, for example, metal and may contain, for example, Al or Cu.

The body 131 includes an opening 134. The window 135 closes the opening 134. The window 135 (i.e., the opening 134) is arranged in the body 131 between the detection subject region A1 and the location of the transmitter 20 and the receiver 30.

The window 135 is larger than the sensor unit 40, which includes the transmitter 20 and the receiver 30, as viewed in the y-direction. The window 135 may be transparent. Alternatively, the window 135 may be opaque.

In the present embodiment, the detection device 10 includes a compartment portion 140 defining the detection subject region A1 together with the body 131 and the window 135.

The compartment portion 140 is formed from a material (e.g., metal) that reflects an electromagnetic wave. In the same manner as the first embodiment, the compartment portion 140 includes a compartment bottom 141, a compartment wall 142, and a flange 143. When the compartment bottom 141 and the window 135 are opposed to each other in the y-direction and the flange 143 is fixed to the second partition wall surface 133 of the body 131, the compartment portion 140 is attached to the compartment member 130. Thus, the detection subject region A1 is formed. The transmitter 20 and the receiver 30, the window 135, the detection subject region A1, and the compartment bottom 141 are arranged in the y-direction.

In the present embodiment, the compartment member 130 and the compartment portion 140 are formed separately. Alternatively, for example, the compartment member 130 and the compartment portion 140 may be formed integrally. In other words, the compartment member 130 may include the body 131, the window 135, and the compartment portion.

In this structure, the transmitter 20 emits the electromagnetic wave toward the detection subject region A1 through the window 135 of the compartment member 130. Thus, the electromagnetic wave emitted from the transmitter 20 transmits through the detection subject region A1 and is reflected by the compartment portion 140 (specifically, the compartment bottom 141). In other words, in the present embodiment, the compartment portion 140, more specifically, the compartment bottom 141, forms a reflector 144.

The electromagnetic wave reflected by the compartment bottom 141 transmits through the detection subject region A1 and the window 135 and reaches the receiver 30. Thus, the receiver 30 receives the electromagnetic wave that is reflected by the reflector 144 and transmitted from the detection subject region A1 through the window 135.

Operation and Advantages

The present embodiment, which has been described above, has the following operational advantages.

(5-1) The compartment member 130 includes the body 131 formed from a material that reflects the electromagnetic wave and the window 135 arranged in the body 131 between the detection subject region A1 and the location of the transmitter 20 and the receiver 30. The window 135 is formed from a material transmissive to an electromagnetic wave. The transmitter 20 emits the electromagnetic wave through the window 135 toward the detection subject region A1. The receiver 30 receives the electromagnetic wave that is reflected by the compartment bottom 141, as the reflector 144, and transmitted from the detection subject region A1 through the window 135.

With this structure, even when the body 131 is formed from a material that reflects the electromagnetic wave such as metal, the detection subject X present in the detection subject region A1 is detected using the electromagnetic wave.

(5-2) The detection device 10 includes the compartment portion 140 defining the detection subject region A1 together with the body 131 and the window 135. The compartment portion 140 is formed from a material that reflects the electromagnetic wave. The receiver 30 receives the electromagnetic wave reflected by the compartment portion 140.

In this structure, the compartment portion 140, which defines the detection subject region A1, is used as the reflector. Thus, there is no need to arrange a reflector separately from the compartment portion 140, and the structure is simplified.

Alternatively, in an example, the compartment portion 140 may be formed from a material that is transmissive to the electromagnetic wave. In this case, a metal film may be formed as a reflector on the inner surface or the outer surface of the compartment bottom 141.

### Sixth Embodiment

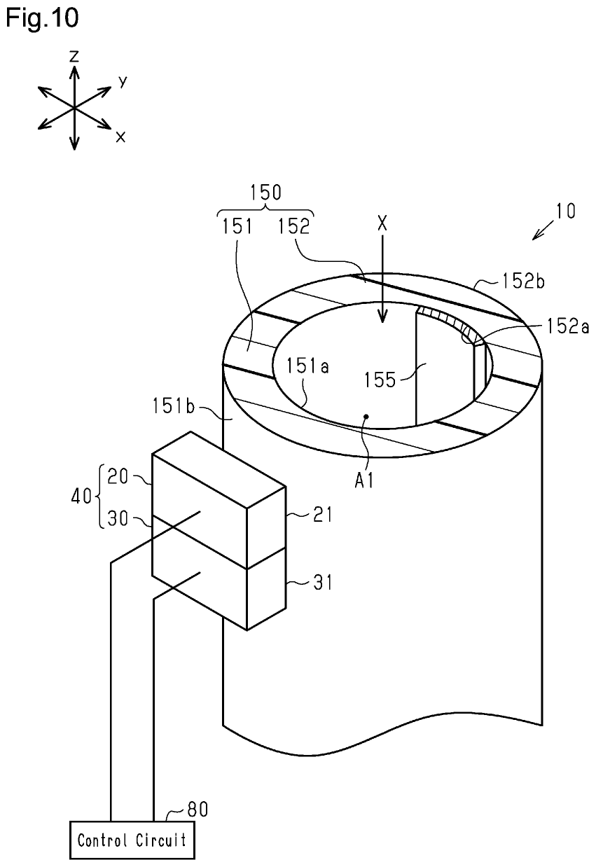

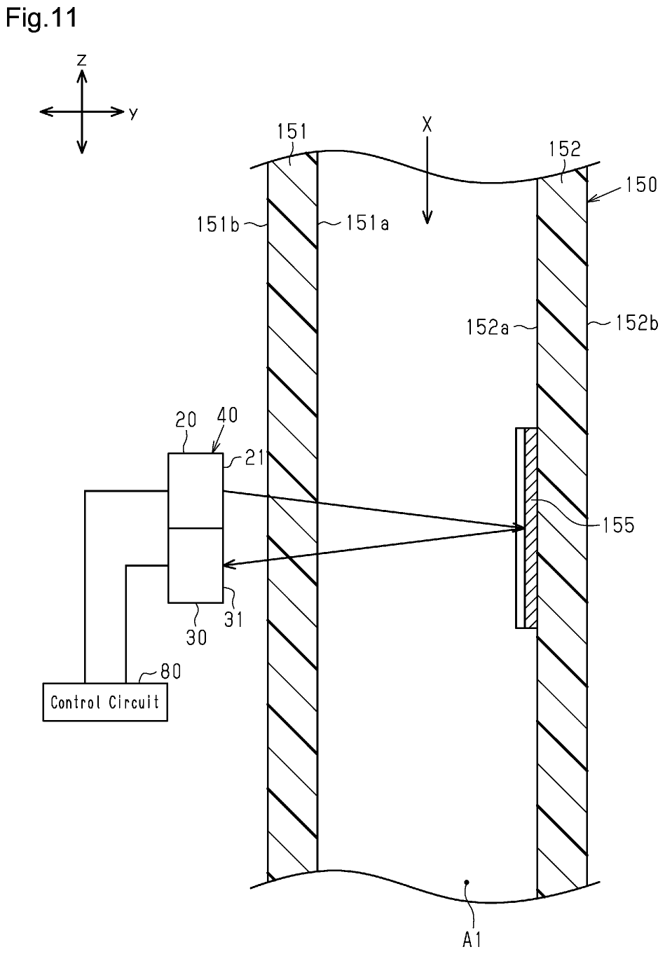

A sixth embodiment of the detection device 10 will now be described with reference to FIGS. 10 and 11. The detection device 10 of the present embodiment differs from the detection device 10 of the first embodiment in the shape of a compartment member 150. In the description below, the same reference characters are given to those components that are the same as the corresponding components of the first embodiment. Such components will not be described in detail.

As shown in FIGS. 10 and 11, in the present embodiment, the compartment member 150 is tubular, and the detection subject X passes through the inner cavity of the compartment member 150. In the present embodiment, the detection subject region A1 is the inner cavity of the compartment member 150. In the present embodiment, the compartment member 150 is formed from a material transmissive to an electromagnetic wave in the same manner as the first embodiment.

The compartment member 150 has the form of, for example, a hollow cylinder of which axial direction conforms to the z-direction. The detection subject region A1 extends in the z-direction. The detection subject X flows in the z-direction. However, the compartment member 150 is not limited to that described above and may have any specific shape.

The compartment member 150 includes a first opposing part 151 and a second opposing part 152 opposed to each other with the detection subject region A1 disposed in between. In the present embodiment, each of the first opposing part 151 and the second opposing part 152 is arcuate as viewed in the z-direction. Ends of the two opposing parts 151 and 152 are joined to each other to form a hollow cylinder. In other words, when the hollow cylindrical compartment member 150 is divided into two parts along the xz-plane, one part is the first opposing part 151, and the other part is the second opposing part 152.

The two opposing parts 151 and 152 are separated from each other in the y-direction except the ends of the opposing parts 151 and 152. The distance between the two opposing parts 151 and 152 differs in accordance with the x-direction. The y-direction may be referred to as the opposing direction of the two opposing parts 151 and 152.

The first opposing part 151 includes a first inner surface 151a defining the detection subject region A1 and a first outer surface 151b opposite to the first inner surface 151a. Also, the second opposing part 152 includes a second inner surface 152a defining the detection subject region A1 and a second outer surface 152b opposite to the second inner surface 152a. The inner circumferential surface of the compartment member 150 is defined by the two inner surfaces 151a and 152a. The detection subject region A1 is surrounded by the two inner surfaces 151a and 152a. The outer circumferential surface of the compartment member 150 is defined by the two outer surfaces 151b and 152b.

The sensor unit 40 (i.e., the transmitter 20 and the receiver 30) is arranged outside the detection subject region A1, and more specifically, opposed to the first outer surface 151b.

Accordingly, a reflector 155 is arranged on the second opposing part 152 and opposed to the transmitter 20.

In the present embodiment, the reflector 155 is arranged separately from the compartment member 150. More specifically, the reflector 155 is formed from a metal film. The reflector 155 is formed, for example, on the second inner surface 152a. In this case, the reflector 155 is located in the detection subject region A1.

The reflector 155, for example, has a width in the x-direction and extends in the z-direction. More specifically, the reflector 155 extends in the x-direction and the z-direction to overlap the transmitter 20 and the receiver 30 as viewed in the y-direction.

In the present embodiment, the reflector 155 is curved along the curve of the second opposing part 152. More specifically, the second inner surface 152a is concaved in a direction away from the sensor unit 40. Accordingly, the reflector 155 is concaved in the direction away from the sensor unit 40. The thickness of the reflector 155 is smaller than the thickness of the compartment member 150.

Operation

The operation of the present embodiment will now be described.

As shown in FIG. 11, the electromagnetic wave emitted from the transmitter 20 transmits through the first opposing part 151 into the detection subject region A1 and is reflected by the reflector 155. The electromagnetic wave reflected by the reflector 155 transmits through the detection subject region A1 and the first opposing part 151 and is received by the receiver 30. In this case, the reception strength changes in accordance with whether the detection subject X is present in the detection subject region A1 or the state of the detection subject X.

Advantages

The present embodiment has the following advantages.

(6-1) The compartment member 150 includes the first opposing part 151 and the second opposing part 152 opposed to each other with the detection subject region A1 disposed in between. The opposing parts 151 and 152 include the inner surfaces 151a and 152a defining the detection subject region A1 and the outer surfaces 151b and 152b opposite to the inner surfaces 151a and 152a. The transmitter 20 and the receiver 30 are opposed to the first outer surface 151b. The reflector 155 is arranged on the second opposing part 152 and opposed to the transmitter 20. Thus, the advantage (1-1) is obtained.

(6-2) The reflector 155 is the metal film arranged on the second inner surface 152a. Thus, the electromagnetic wave is reflected. In particular, in this structure, the electromagnetic wave does not need to transmit through the second opposing part 152. This limits attenuation of the electromagnetic wave that may result from transmission of the electromagnetic wave through the second opposing part 152. Thus, a decrease in the reception strength is limited.

(6-3) The compartment member 150 has the form of a tube in which the ends of the two opposing parts 151 and 152 are joined to each other. The detection subject region A1 is the inner cavity of the compartment member 150. With this structure, the detection subject X passing in the tubular compartment member 150 is detected.

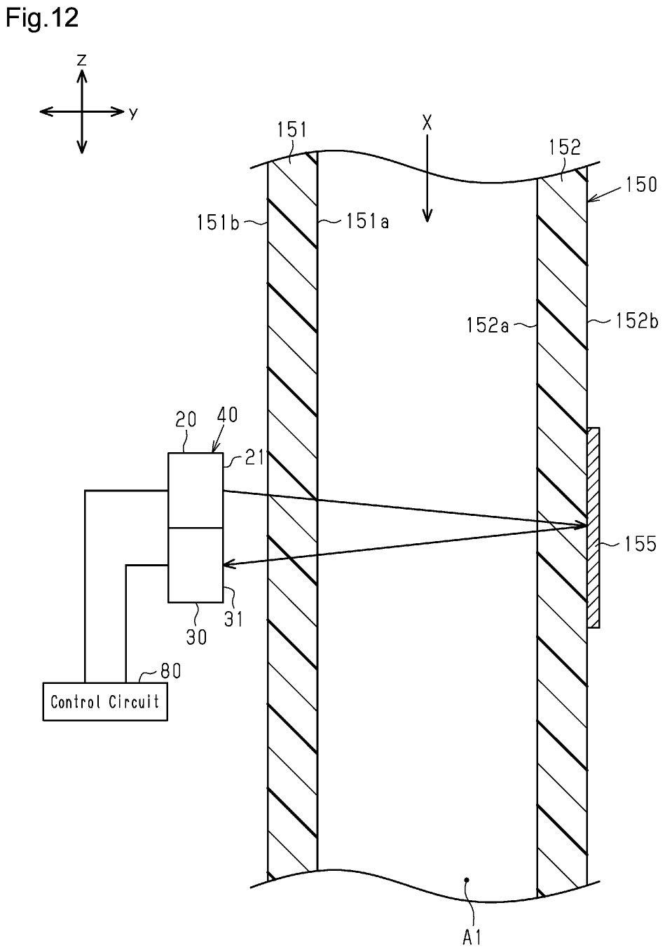

As shown in FIG. 12, the reflector 155 may be formed on the second outer surface 152b. In this case, the reflector 155 is located outside the detection subject region A1. This structure also obtains the advantage (1-1). With this structure, the reflector 155 may be relatively easily installed later.

Alternatively, the compartment member 150 may have the form of a polygonal tube (e.g., rectangular tube). In this case, when the first opposing part 151 is one of the walls of the compartment member 150 having the form of a polygonal tube, the second opposing part 152 may be one of the walls that is opposed to the first opposing part 151 with the detection subject region A1 disposed in between.

### Seventh Embodiment

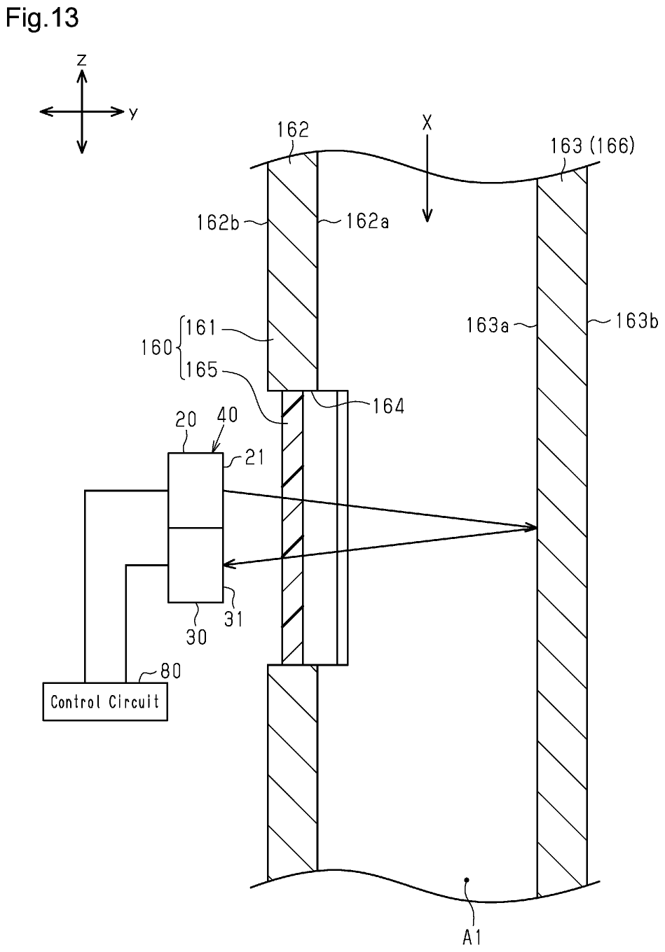

A seventh embodiment of the detection device 10 will now be described with reference to FIG. 13. The detection device 10 of the present embodiment differs from the detection device 10 of the sixth embodiment in the structure of a compartment member 160. In the description below, the same reference characters are given to those components that are the same as the corresponding components of the sixth embodiment. Such components will not be described in detail.

In the present embodiment, as shown in FIG. 13, the compartment member 160 includes a body 161 and a window 165.

In the present embodiment, the body 161 is formed from a material that reflects an electromagnetic wave. In the same manner as the sixth embodiment, the body 161 is tubular and includes two opposing parts 162 and 163 opposed to each other with the detection subject region A1 disposed in between.

The first opposing part 162 includes a first inner surface 162a defining the detection subject region A1 and a first outer surface 162b opposite to the first inner surface 162a. Also, the second opposing part 163 includes a second inner surface 163a defining the detection subject region A1 and a second outer surface 163b opposite to the second inner surface 163a. The inner circumferential surface of the compartment member 160 is defined by the two inner surfaces 162a and 163a. The detection subject region A1 is surrounded by the two inner surfaces 162a and 163a. The outer circumferential surface of the compartment member 160 is defined by the two outer surfaces 162b and 163b.

In the present embodiment, the body 161 includes an opening 164. The window 165 closes the opening 164. The window 165 is formed from a material transmissive to an electromagnetic wave. The window 165 (i.e., the opening 164) is large enough to overlap both the transmitter 20 and the receiver 30 as viewed in the y-direction.

The thickness of the window 165 is, for example, smaller than the thickness of the body 161. Alternatively, the thickness of the window 165 may be equal to the thickness of the body 161 or larger than the thickness of the body 161.

The window 165 is arranged in the body 161 between the location of the transmitter 20 and the receiver 30 and the detection subject region A1. More specifically, in the same manner as the sixth embodiment, the transmitter 20 and the receiver 30 are opposed to the first outer surface 162b of the first opposing part 162. Accordingly, the window 165 is arranged in a portion of the first opposing part 162 located between the sensor unit 40 and the detection subject region A1, that is, a portion of the first opposing part 162 opposed to the sensor unit 40. Thus, the sensor unit 40, the window 165, the detection subject region A1, and the second opposing part 163 are arranged in the y-direction.

The positional relationship of the window 165 and the second opposing part 163 may be described as the second opposing part 163 is opposed to the window 165 or as the second opposing part 163 includes a portion opposed to the window 165 with the detection subject region A1 disposed in between.

The transmitter 20 emits the electromagnetic wave through the window 165 toward the detection subject region A1. The electromagnetic wave enters the detection subject region A1 and reaches the second opposing part 163, more specifically, the portion of the second opposing part 163 opposed to the window 165. The electromagnetic wave is reflected by the second opposing part 163. Thus, in the present embodiment, the second opposing part 163 is used as a reflector 166. In other words, in the present embodiment, the compartment member 160 includes the second opposing part 163 used as the reflector 166.

The electromagnetic wave reflected by the second opposing part 163 transmits through the detection subject region A1 and the window 165 and reaches the receiver 30. Thus, the receiver 30 receives the electromagnetic wave that is reflected by the second opposing part 163 and transmitted from the detection subject region A1 through the window 165.

The second opposing part 163 is concaved in a direction away from the receiver 30. Hence, the electromagnetic wave reflected by the second opposing part 163 is collected and transmitted toward the receiver 30.

Operation and Advantages

The present embodiment, which has been described above, has the following operational advantages.

(7-1) The compartment member 160 includes the body 161 formed from a material that reflects the electromagnetic wave. The body 161 includes the first opposing part 162 and the second opposing part 163 opposed to each other with the detection subject region A1 disposed in between. The window 165 is arranged on the first opposing part 162 and opposed to the transmitter 20 and the receiver 30. The reflector 166 is arranged on the second opposing part 163 and opposed to the window 165.

With this structure, the electromagnetic wave is emitted and received through the window 165. Thus, even when the body 161 is formed from a material that reflects the electromagnetic wave, the detection subject X present in the detection subject region A1 is detected.

### Modified Examples

The embodiments exemplify, without any intention to limit, applicable forms of a detection device and a detection method according to the present disclosure. The detection device and the detection method according to the present disclosure may be applicable to forms differing from the above embodiments. In an example of such a form, the structure of the embodiments is partially replaced, changed, or omitted, or a further structure is added to the embodiments. The embodiments and the modified examples described below may be combined with one another as long as there is no technical inconsistency. In the modified examples, the same reference characters are given to those components that are the same as the corresponding components of the above embodiments. Such components will not be described in detail.

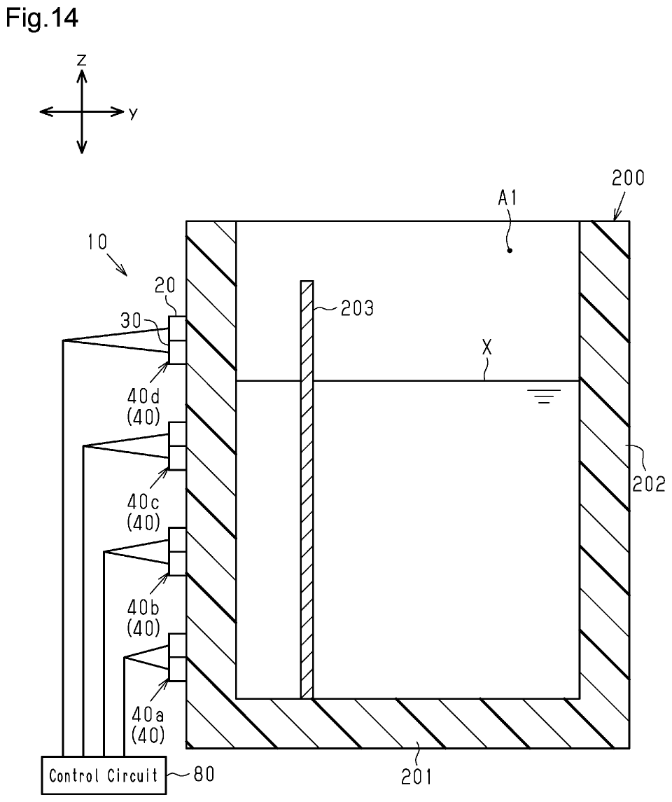

As shown in FIG. 14, the partition member may be an accommodation member 200 configured to accommodate the detection subject X. In an example, the accommodation member 200 includes a bottom 201 and a side portion 202 extending upright from the bottom 201 in the height-wise direction (in the modified example, the z-direction). In an example, the bottom 201 is plate-shaped and is orthogonal to the z-direction. The bottom 201 may have any specific shape and may be, for example, polygonal, circular, and oval as viewed in the z-direction.

The side portion 202 extends from a peripheral edge of the bottom 201 in the z-direction and is annular as viewed in the z-direction. The bottom 201 and the side portion 202 define an inner cavity accommodating the detection subject X. In this modified example, the detection subject region A1 is the inner cavity of the accommodation member 200.

In this structure, multiple sensor units 40 including transmitters 20 and receivers 30, are arranged on the side portion 202 at a predetermined interval in the height-wise direction. The transmitter 20 of each sensor unit 40 emits the electromagnetic wave toward the side portion 202 in the y-direction.

In FIG. 14, four sensor units 40 are arranged. However, the number of sensor units 40 may be changed in any manner and may be two or five or more. The interval of adjacent ones of the sensor units 40 may be the same or different.

In this structure, the detection device 10 may include a reflection wall 203 opposed to the sensor units 40 with the side portion 202 and at least part of the detection subject region A1 disposed in between. The reflection wall 203 is formed from a material (e.g., metal) that reflects an electromagnetic wave. The transmitter 20 and the receiver 30 of each sensor unit 40 are opposed to the reflection wall 203 in the y-direction. The reflection wall 203 corresponds to the “reflector.”

The reflection wall 203 shown in FIG. 14 is arranged in the detection subject region A1 and extends upright from the bottom 201. In an example, the reflection wall 203 is located closer to the side portion 202 where the sensor units 40 are arranged than the center of the bottom 201.

With this structure, the electromagnetic wave emitted from the transmitter 20 of each sensor unit 40 transmits in the y-direction through the side portion 202 and part of the detection subject region A1 and reaches the reflection wall 203. The electromagnetic wave is reflected by the reflection wall 203. The reflected electromagnetic wave transmits again through part of the detection subject region A1 and the side portion 202 and reaches the receiver 30. Thus, the height of the detection subject X is measured.

For the sake of convenience, the sensor units 40 upward from the bottom 201 are sequentially referred to as a first sensor unit 40a, a second sensor unit 40b, a third sensor unit 40c, and a fourth sensor unit 40d. The detection subject X may be a liquid, and the liquid level of the detection subject X may be located between the third sensor unit 40c and the fourth sensor unit 40d. In this case, the first sensor unit 40a to the third sensor unit 40c detect the detection subject X. The fourth sensor unit 40d does not detect the detection subject X. Therefore, it is assumed that the accommodation member 200 is filled with the detection subject X to a height between the third sensor unit 40c and the fourth sensor unit 40d. Thus, the height of the detection subject X is detected.

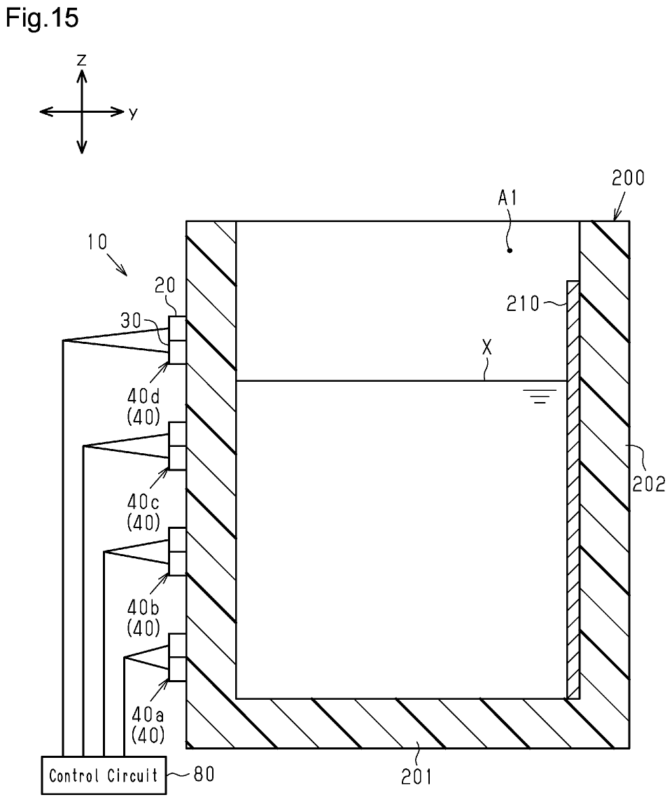

As shown in FIG. 15, instead of the reflection wall 203, a reflector 210 may be arranged on the inner surface of the side portion 202 and opposed to the sensor units 40a to 40d with the detection subject region A1 disposed in between.

The transmitter 20 may include a mirror that reflects the electromagnetic wave emitted from the emission surface 21. In this structure, the electromagnetic wave reflected by the mirror may be emitted into the detection subject region A1 through the partition members 50, 120, 130, 150, and 160.

In the first embodiment, the portion of the partition member 50 opposed to the sensor unit 40 may have a smaller thickness than the remaining portion of the partition member 50. The portion of the partition member 50 opposed to the sensor unit 40 may have a larger thickness than the remaining portion of the partition member 50.

In the third embodiment, the number of mirror portions may be three or more. More specifically, as long as the electromagnetic wave emitted from the transmitter 20 transmits via the multiple mirror portions and reaches the receiver 30, the structure may be changed in any manner.

In the fifth embodiment, the window 135 may separately include a first window corresponding to the transmitter 20 and a second window corresponding to the receiver 30. The first window may be, for example, arranged to be opposed to the transmitter 20 so as not to hinder the electromagnetic wave emitted from the transmitter 20. Also, the second window may be, for example, arranged to be opposed to the receiver 30 so as not to hinder the electromagnetic wave received by the receiver 30. More specifically, the window may be a single window large enough to be opposed to both the transmitter 20 and the receiver 30 or may be two or more windows respectively arranged for the transmitter 20 and the receiver 30.

The transmitter 20 and the receiver 30 do not necessarily have to be unitized. Each of the transmitter 20 and the receiver 30 may be fixed to the partition member or the compartment member.

In an example, the emission surface 21 may be inclined from the y-direction. In this structure, the reflector may be arranged in a direction orthogonal to the emission surface 21 so that the reflector is opposed to the emission surface 21. In the same manner, the reception surface 31 may be inclined from the y-direction. In this structure, the reflector may be arranged in a direction orthogonal to the reception surface 31 so that the reflector is opposed to the reception surface 31.

The direction in which the transmitter 20 is opposed to the reflector may be parallel to or intersect with the direction in which the receiver 30 is opposed to the reflector. In an example, the opposing direction of the transmitter 20 and the reflector and the opposing direction of the receiver 30 and the reflector may form an angle that is less than 90 degrees or an angle that is greater than or equal to 90 degrees. The electromagnetic wave reflected by the reflector may reach the receiver 30 without transmitting through the detection subject region A1.

The detection subject X may be solid. The detection subject X may be inorganic or organic. The detection subject X may be a person. In other words, the detection device 10 may be a human presence sensor that detects a person in the detection subject region A1.

As long as the transmitter 20 emits an electromagnetic wave through a partition member toward the detection subject region A1 and the receiver 30 receives the electromagnetic wave that is reflected, the detection device 10 may, but does not necessarily have to, include the partition member.

The detection device 10 does not necessarily have to include a reflector. As long as the receiver 30 receives the electromagnetic wave that is reflected by a reflector and transmitted through at least part of the detection subject region A1 and the compartment member, the detection device 10 may, but does not necessarily have to, include the reflector.

In the present disclosure, a structure described as “A overlaps B as viewed in a direction” includes a structure in which the entirety of A overlaps B and a structure in which a portion of A overlaps B unless otherwise clearly indicated in the context.

The z-direction as referred to in the present disclosure does not necessarily have to be the vertical direction and does not necessarily have to fully conform to the vertical direction. In the structures according to the present disclosure, “upward” and “downward” in the z-direction as referred to in the present description are not limited to “upward” and “downward” in the vertical direction. In an example, the x-direction may conform to the vertical direction. In another example, the y-direction may conform to the vertical direction.

In this specification, “at least one of A and B” should be understood to mean “only A, only B, or both A and B.”

### Clauses

The technical aspects that are understood from the embodiments and the modified examples will be described below. The reference signs of the elements in the embodiments are given to the corresponding elements in clauses with parentheses. The reference signs used as examples to facilitate understanding, and the elements in each clause are not limited to those elements given with the reference signs.

[Clause A1]

A detection device (10), including:
a transmitter (20) configured to generate an electromagnetic wave and emit the electromagnetic wave toward a detection subject region (A1);
a reflector (61 (70), 101, 111, 125, 141 (144), 155, 163 (166), 203, 210) arranged in an optical path of an electromagnetic wave emitted from the transmitter and configured to reflect the electromagnetic wave transmitted through at least part of the detection subject region; and
a receiver (30) configured to receive the electromagnetic wave reflected by the reflector, in which
the transmitter is configured to emit an electromagnetic wave toward the detection subject region through a partition member (50,120,130,150,160,200) that partitions the transmitter and the receiver from the detection subject region, and
the receiver is configured to receive an electromagnetic wave that is reflected by the reflector and transmitted from the detection subject region through the partition member.

[Clause A2]

The detection device according to clause A1, in which the partition member (50, 120, 150, 200) is formed from a material that is transmissive to an electromagnetic wave.

[Clause A3]

The detection device according to clause A2, further including:
a compartment member (60) attached to the partition member and defining the detection subject region together with the partition member, in which
the compartment member is formed from a material that reflects an electromagnetic wave, and
the receiver is configured to receive an electromagnetic wave that is reflected by the compartment member, which is used as the reflector, and transmitted from the detection subject region through the partition member.

[Clause A4]

The detection device according to clause A2, in which
the partition member includes a first opposing part (151) and a second opposing part (152) opposed to each other with the detection subject region disposed in between,
the first opposing part includes a first inner surface (151a) defining the detection subject region and a first outer surface (151b) opposite to the first inner surface,
the second opposing part includes a second inner surface (152a) defining the detection subject region and a second outer surface (152b) opposite to the second inner surface,
the transmitter and the receiver are arranged to be opposed to the first outer surface, and
the reflector (155) is arranged on the second opposing part and opposed to the transmitter.

[Clause A5]

The detection device according to clause A4, in which the reflector (155) is arranged on the second inner surface.

[Clause A6]

The detection device according to clause A4, in which the reflector (155) is arranged on the second outer surface.

[Clause A7]

The detection device according to clause A5 or A6, in which
the partition member is cylindrical and hollow,
the first opposing part and the second opposing part are arcuately curved, and
the reflector is curved along the second opposing part.

[Clause A8]

The detection device according to clause A2, in which
the partition member includes an accommodation member (200) including a bottom (201) and a side portion (202) extending upright from the bottom in a height-wise direction and configured to accommodate a detection subject,
the detection subject region includes an inner cavity of the accommodation member,
sensor units (40) each include the transmitter and the receiver and are arranged on the side portion at a predetermined interval in the height-wise direction, and
the reflector (203) extends upright from the bottom and is opposed to the sensor units with the side portion and at least part of the detection subject region disposed in between.

[Clause A9]

The detection device according to clause A1, in which
the partition member includes
a body (131, 161) formed from a material that reflects an electromagnetic wave, and
a window (135, 165) arranged on a portion of the body located between the detection subject region and each of the transmitter and the receiver, the window being formed from a material that is transmissive to an electromagnetic wave,
the transmitter emits an electromagnetic wave through the window toward the detection subject region, and
the receiver is configured to receive an electromagnetic wave that is reflected by the reflector and transmitted from the detection subject region through the window.

[Clause A10]

The detection device according to clause A9, further including:
a compartment portion (140) defining the detection subject region together with the body (131) and the window (134), in which
the compartment portion is formed from a material that reflects an electromagnetic wave and forms the reflector (144), and
the receiver is configured to receive an electromagnetic wave reflected by the compartment portion.

[Clause A11]

The detection device according to clause A9, in which
the body (161) includes a first opposing part (162) and a second opposing part (163) opposed to each other with the detection subject region disposed in between,
the first opposing part includes a first inner surface (162a) defining the detection subject region and a first outer surface (162b) opposite to the first inner surface,
the second opposing part includes a second inner surface (163a) defining the detection subject region and a second outer surface (163b) opposite to the second inner surface,
the transmitter and the receiver are arranged to be opposed to the first outer surface,
the window (165) is arranged on the first opposing part and opposed to the transmitter and the receiver, and
the reflector is arranged on the second opposing part and opposed to the window.

[Clause A12]

The detection device according to clause A1, in which
the reflector (61 (70), 101, 111, 125, 141 (144), 155, 163 (166), 203, 210) is arranged to be opposed to the transmitter with the partition member and the detection subject region disposed in between,
the receiver is arranged to be opposed to the reflector with the partition member and the detection subject region disposed in between, and
the receiver is configured to receive an electromagnetic wave that is reflected by the reflector and transmitted through the detection subject region and the partition member.

[Clause A13]

The detection device according to clause A12, in which
the reflector (101) includes a curved portion arranged separately from the transmitter in an emission direction of an electromagnetic wave emitted from the transmitter, and
the curved portion is concaved in the emission direction.

[Clause A14]

The detection device according to clause A1, in which
the reflector (111,125) includes multiple mirror portions including
a first mirror portion (112, 126) arranged separately from the transmitter in an emission direction of an electromagnetic wave emitted from the transmitter, the first mirror portion being configured to reflect an electromagnetic wave emitted from the transmitter, and
a second mirror portion (113, 127) configured to further reflect the electromagnetic wave reflected by the first mirror portion,
the detection subject region is located between the first mirror portion and the second mirror portion, and
an electromagnetic wave emitted from the transmitter is configured to transmit via the multiple mirror portions and reach the receiver.

[Clause A15]

The detection device according to clause A14, in which
the receiver is configured to receive an electromagnetic wave reflected by the second mirror portion,
the first mirror portion (112) is concaved in an emission direction of an electromagnetic wave emitted from the transmitter, and
the second mirror portion (113) is concaved in a direction away from the receiver.

[Clause A16]

The detection device according to clause A1, in which the reflector (155) is arranged outside the detection subject region.

[Clause A17]

The detection device according to clause A1, in which the reflector (111, 125, 155) is arranged inside the detection subject region.

[Clause A18]

The detection device according to any one of clauses A1 to A17, in which the transmitter emits an electromagnetic wave including a terahertz wave.

[Clause A19]

The detection device according to any one of clauses A1 to A18, in which
the detection device is configured to detect whether a detection subject is present in the detection subject region or a state of the detection subject, and
the detection subject includes a gas or a liquid.

[Clause A20]

The detection device according to any one of clauses A1 to A19, further including:
a control circuit that determines whether a detection subject is present or a state of the detection subject based on strength of an electromagnetic wave emitted from the transmitter and strength of an electromagnetic wave received by the receiver.

[Clause B1]

A method for detecting a detection subject (X) present in a detection subject region (A1) using a detection device (10) that includes a transmitter (20) configured to generate an electromagnetic wave and a receiver (30) configured to receive an electromagnetic wave, the method including:
emitting an electromagnetic wave from the transmitter toward the detection subject region through a partition member (50, 120, 130, 150, 160, 200) that partitions the transmitter and the receiver from the detection subject region;
with a reflector (61 (70), 101, 111, 125, 141 (144), 155, 163 (166), 203, 210) arranged in an optical path of an electromagnetic wave emitted from the transmitter, reflecting an electromagnetic wave transmitted through at least part of the detection subject region; and
with the receiver, receiving an electromagnetic wave that is reflected by the reflector and transmitted from the detection subject region through the partition member.

[Clause B2]

The method according to clause B1, in which the partition member (50, 120, 150, 200) is formed from a material that is transmissive to an electromagnetic wave.

[Clause B3]

The method according to clause B2, in which
the detection device includes a compartment member (60) attached to the partition member and defining the detection subject region together with the partition member,
the compartment member is formed from a material that reflects an electromagnetic wave, and
the receiver is configured to receive an electromagnetic wave that is reflected by the compartment member, which is used as the reflector, and transmitted from the detection subject region through the partition member.

[Clause B4]

The method according to clause B2, in which
the partition member includes a first opposing part (151) and a second opposing part (152) opposed to each other with the detection subject region disposed in between,
the first opposing part includes a first inner surface (151a) defining the detection subject region and a first outer surface (151b) opposite to the first inner surface,
the second opposing part includes a second inner surface (152a) defining the detection subject region and a second outer surface (152b) opposite to the second inner surface,
the transmitter and the receiver are arranged to be opposed to the first outer surface, and
the reflector (155) is arranged on the second opposing part and opposed to the transmitter.

[Clause B5]

The method according to clause B4, in which the reflector (155) is arranged on the second inner surface.

[Clause B6]

The method according to clause B4, in which the reflector (155) is arranged on the second outer surface.

[Clause B7]

The method according to clause B5 or B6, in which
the partition member is cylindrical and hollow,
the first opposing part and the second opposing part are arcuately curved, and
the reflector is curved along the second opposing part.

[Clause B8]

The method according to clause B2, in which
the partition member includes an accommodation member (200) including a bottom (201) and a side portion (202) extending upright from the bottom in a height-wise direction and configured to accommodate a detection subject,
the detection subject region includes an inner cavity of the accommodation member,
sensor units (40) each include the transmitter and the receiver and are arranged on the side portion at a predetermined interval in the height-wise direction, and
the reflector (203) extends upright from the bottom and is opposed to the sensor units with the side portion and at least part of the detection subject region disposed in between.

[Clause B9]

The method according to clause B1, in which
the partition member includes
a body (131, 161) formed from a material that reflects an electromagnetic wave, and
a window (135, 165) arranged on a portion of the body located between the detection subject region and each of the transmitter and the receiver, the window being formed from a material that is transmissive to an electromagnetic wave,
the transmitter emits an electromagnetic wave through the window toward the detection subject region, and
the receiver is configured to receive an electromagnetic wave that is reflected by the reflector and transmitted from the detection subject region through the window.

[Clause B10]

The method according to clause B9, including
a compartment portion (140) defining the detection subject region together with the body (131) and the window (134), in which
the compartment portion is formed from a material that reflects an electromagnetic wave and forms the reflector (144), and
the receiver is configured to receive an electromagnetic wave reflected by the compartment portion.

[Clause B11]

The method according to clause B9, in which
the body (161) includes a first opposing part (162) and a second opposing part (163) opposed to each other with the detection subject region disposed in between,
the first opposing part includes a first inner surface (162a) defining the detection subject region and a first outer surface (162b) opposite to the first inner surface,
the second opposing part includes a second inner surface (163a) defining the detection subject region and a second outer surface (163b) opposite to the second inner surface,
the transmitter and the receiver are arranged to be opposed to the first outer surface,
the window (165) is arranged on the first opposing part and opposed to the transmitter and the receiver, and
the reflector is arranged on the second opposing part and opposed to the window.

[Clause B12]

The method according to clause B1, in which
the reflector (61 (70), 101, 111, 125, 141 (144), 155, 163 (166), 203, 210) is arranged to be opposed to the transmitter with the partition member and the detection subject region disposed in between, and
the receiver is arranged to be opposed to the reflector with the partition member and the detection subject region disposed in between, and the receiver is configured to receive an electromagnetic wave that is reflected by the reflector and transmitted through the detection subject region and the partition member.

[Clause B13]

The method according to clause B12, in which the reflector (101) includes a curved portion arranged separately from the transmitter in an emission direction of an electromagnetic wave emitted from the transmitter, and the curved portion is concaved in the emission direction.

[Clause B14]

The method according to clause B1, in which
the reflector (111, 125) includes multiple mirror portions including
a first mirror portion (112, 126) arranged separately from the transmitter in an emission direction of an electromagnetic wave emitted from the transmitter, the first mirror portion being configured to reflect an electromagnetic wave emitted from the transmitter, and
a second mirror portion (113, 127) configured to further reflect the electromagnetic wave reflected by the first mirror portion,
the detection subject region is located between the first mirror portion and the second mirror portion, and
an electromagnetic wave emitted from the transmitter transmits via the multiple mirror portions and reach the receiver.

[Clause B15]

The method according to clause B14, in which
the receiver is configured to receive an electromagnetic wave reflected by the second mirror portion,
the first mirror portion (112) is concaved in an emission direction of an electromagnetic wave emitted from the transmitter, and
the second mirror portion (113) is concaved in a direction away from the receiver.

[Clause B16]

The method according to clause B1, in which the reflector (155) is arranged outside the detection subject region.

[Clause B17]

The method according to clause B1, in which the reflector (111, 125, 155) is arranged inside the detection subject region.

[Clause B18]

The method according to any one of clauses B1 to B17, in which the transmitter emits an electromagnetic wave including a terahertz wave.

[Clause B19]

The method according to any one of clauses B1 to B18, in which the detection subject includes a gas or a liquid.

[Clause B20]

The method according to any one of clauses B1 to B19, including determining whether the detection subject is present or a state of the detection subject based on strength of an electromagnetic wave emitted from the transmitter and strength of an electromagnetic wave received by the receiver.

1. A detection device, comprising:
a transmitter configured to generate an electromagnetic wave and emit the electromagnetic wave toward a detection subject region;
a reflector arranged in an optical path of an electromagnetic wave emitted from the transmitter and configured to reflect the electromagnetic wave transmitted through at least part of the detection subject region; and
a receiver configured to receive the electromagnetic wave reflected by the reflector, wherein
the transmitter is configured to emit an electromagnetic wave toward the detection subject region through a partition member that partitions the transmitter and the receiver from the detection subject region, and
the receiver is configured to receive an electromagnetic wave that is reflected by the reflector and transmitted from the detection subject region through the partition member.

2. The detection device according to claim 1, wherein the partition member is formed from a material that is transmissive to an electromagnetic wave.

3. The detection device according to claim 2, further comprising:
a compartment member attached to the partition member and defining the detection subject region together with the partition member, wherein
the compartment member is formed from a material that reflects an electromagnetic wave, and
the receiver is configured to receive an electromagnetic wave that is reflected by the compartment member, which is used as the reflector, and transmitted from the detection subject region through the partition member.

4. The detection device according to claim 2, wherein
the partition member includes a first opposing part and a second opposing part opposed to each other with the detection subject region disposed in between,
the first opposing part includes a first inner surface defining the detection subject region and a first outer surface opposite to the first inner surface,
the second opposing part includes a second inner surface defining the detection subject region and a second outer surface opposite to the second inner surface,
the transmitter and the receiver are arranged to be opposed to the first outer surface, and
the reflector is arranged on the second opposing part and opposed to the transmitter.

5. The detection device according to claim 4, wherein the reflector is arranged on the second inner surface.

6. The detection device according to claim 4, wherein the reflector is arranged on the second outer surface.

7. The detection device according to claim 5, wherein
the partition member is cylindrical and hollow,
the first opposing part and the second opposing part are arcuately curved, and
the reflector is curved along the second opposing part.

8. The detection device according to claim 2, wherein
the partition member includes an accommodation member including a bottom and a side portion extending upright from the bottom in a height-wise direction and configured to accommodate a detection subject,
the detection subject region includes an inner cavity of the accommodation member,
sensor units each include the transmitter and the receiver and are arranged on the side portion at a predetermined interval in the height-wise direction, and
the reflector extends upright from the bottom and is opposed to the sensor units with the side portion and at least part of the detection subject region disposed in between.

9. The detection device according to claim 1, wherein
the partition member includes
a body formed from a material that reflects an electromagnetic wave, and
a window arranged on a portion of the body located between the detection subject region and each of the transmitter and the receiver, the window being formed from a material that is transmissive to an electromagnetic wave,
the transmitter emits an electromagnetic wave through the window toward the detection subject region, and
the receiver is configured to receive an electromagnetic wave that is reflected by the reflector and transmitted from the detection subject region through the window.

10. The detection device according to claim 9, further comprising:
a compartment portion defining the detection subject region together with the body and the window, wherein
the compartment portion is formed from a material that reflects an electromagnetic wave and forms the reflector, and
the receiver is configured to receive an electromagnetic wave reflected by the compartment portion.

11. The detection device according to claim 9, wherein
the body includes a first opposing part and a second opposing part opposed to each other with the detection subject region disposed in between,
the first opposing part includes a first inner surface defining the detection subject region and a first outer surface opposite to the first inner surface,
the second opposing part includes a second inner surface defining the detection subject region and a second outer surface opposite to the second inner surface,
the transmitter and the receiver are arranged to be opposed to the first outer surface,
the window is arranged on the first opposing part and opposed to the transmitter and the receiver, and
the reflector is arranged on the second opposing part and opposed to the window.

12. The detection device according to claim 1, wherein
the reflector is arranged to be opposed to the transmitter with the partition member and the detection subject region disposed in between,
the receiver is arranged to be opposed to the reflector with the partition member and the detection subject region disposed in between, and
the receiver is configured to receive an electromagnetic wave that is reflected by the reflector and transmitted through the detection subject region and the partition member.

13. The detection device according to claim 12, wherein
the reflector includes a curved portion arranged separately from the transmitter in an emission direction of an electromagnetic wave emitted from the transmitter, and
the curved portion is concaved in the emission direction.

14. The detection device according to claim 1, wherein
the reflector includes multiple mirror portions including
a first mirror portion arranged separately from the transmitter in an emission direction of an electromagnetic wave emitted from the transmitter, the first mirror portion being configured to reflect an electromagnetic wave emitted from the transmitter, and
a second mirror portion configured to further reflect the electromagnetic wave reflected by the first mirror portion,
the detection subject region is located between the first mirror portion and the second mirror portion, and
an electromagnetic wave emitted from the transmitter is configured to transmit via the multiple mirror portions and reach the receiver.

15. The detection device according to claim 14, wherein
the receiver is configured to receive an electromagnetic wave reflected by the second mirror portion,
the first mirror portion is concaved in an emission direction of an electromagnetic wave emitted from the transmitter, and
the second mirror portion is concaved in a direction away from the receiver.

16. The detection device according to claim 1, wherein the reflector is arranged outside the detection subject region.

17. The detection device according to claim 1, wherein the reflector is arranged inside the detection subject region.

18. The detection device according to claim 1, wherein the transmitter emits an electromagnetic wave including a terahertz wave.

19. The detection device according to claim 1, wherein
the detection device is configured to detect whether a detection subject is present in the detection subject region or a state of the detection subject, and
the detection subject includes a gas or a liquid.

20. A method for detecting a detection subject present in a detection subject region using a detection device that includes a transmitter configured to generate an electromagnetic wave and a receiver configured to receive an electromagnetic wave, the method comprising:
emitting an electromagnetic wave from the transmitter toward the detection subject region through a partition member that partitions the transmitter and the receiver from the detection subject region;
with a reflector arranged in an optical path of an electromagnetic wave emitted from the transmitter, reflecting an electromagnetic wave transmitted through at least part of the detection subject region; and
with the receiver, receiving an electromagnetic wave that is reflected by the reflector and transmitted from the detection subject region through the partition member.
